(19) United States
(12) Patent Application Publication
(10) Pub. No.: US 2009/0224598 A1
(43) Pub. Date: Sep. 10, 2009

(54) METHOD FOR COMPRESSION MOULDING REINFORCED THERMOPLASTIC ARTICLE

(76) Inventors: Pascal St-Amant, Drummondville (CA); Nicolas Demers, Drummondville (CA); Norman O. Berg, Roseau, MN (US)

Correspondence Address: BROUILLETTE & PARTNERS, METCALFE TOWER, 1550 METCALFE STREET, SUITE 800, MONTREAL, QC, H3A-1X6, CA

(21) Appl. No.: 12/162,552

(22) PCT Filed: Feb. 21, 2007
(86) PCT No.: PCT/CA2007/000267

§ 371 Date: Jan. 19, 2009

(30) Foreign Application Priority Data
Feb. 21, 2006 (CA) 2537042

(51) Int. Cl. B62D 55/00; B29C 43/18

(52) U.S. Cl. 305/165; 264/258

(57) ABSTRACT

A method for manufacturing a polymeric article having an integrated reinforcing element. A thermoplastic material is introduced into a mould, after which reinforcing elements are inserted into the mould cavity. A second layer of the thermoplastic material is introduced into the mould, after which the mould is closed, pressing and heating the mould to melt the thermoplastic material and form the article. The thermoplastic layers may be provided in powder, sheet, or pellet form. The reinforcing elements may comprise reinforcing fibres or reinforcing fabrics. A polymeric track for a vehicle may be produced from this method.

### CROSS-REFERENCE TO RELATED APPLICATIONS

The present patent application claims the benefits of priority of commonly assigned Canadian Patent Application no. 2,537,042, filed on Feb. 21, 2006, at the Canadian Intellectual Property Office.

### FIELD OF THE INVENTION

The present invention relates to endless traction bands or tracks that are used to propel track laying vehicles. Without being limitative in nature, the present invention particularly relates to continuous and/or segmented endless tracks made from polymeric materials and to method for making such tracks.

### BACKGROUND OF THE INVENTION

Numerous types of vehicles are frequently used in terrain in which it is difficult for pneumatic tires to operate. Both military vehicles (e.g. tanks, armoured carriers, amphibious vehicles) and civilian vehicles (e.g. agricultural equipments and tractors, construction equipments and excavators, forestry equipments, skid-steers, recreational vehicles, snowmobiles, all-terrain vehicles, etc.) are sometime utilized on terrains which are very soft, for example sand, snow and/or mud surfaces. Generally, pneumatic tires are not capable of efficient operation on such soft surfaces, as they tend to burrow into the surface, rather than riding across the surface.

In order to overcome the problems encountered with pneumatic tires, endless track vehicles have been developed for use on terrains in which pneumatic tire equipped vehicles are impractical.

Due to the large spectrum of vehicles onto which endless tracks are now used, endless tracks now come in a multiplicity of designs and configurations. Hence, the endless track spectrum now extends between the older style metallic tracks made of a plurality of metallic segments pivotally connected to each other and the more recent endless elastomeric tracks made from reinforced rubber and/or analogous elastomeric materials. Understandably, the prior art is replete with variants and combinations of different kinds of endless tracks.

Still, there is a general tendency to increasingly push the design of endless tracks toward elastomeric tracks due to the fact that they are generally lighter and generally more energy efficient than metallic tracks, they generate less noise and they can travels over paved surfaces without damaging them.

Nevertheless, due to physical characteristics of elastomers, elastomeric tracks generally comprise a multitude of reinforcing elements, embedded therein, in order to provide longitudinal and/or lateral structural integrity and rigidity and/or to prevent excessive deformation thereof. These reinforcing elements, though generally necessary, can add significant weight to the tracks and therefore limit their energy efficiency. Consequently, there is still room for improvements in the design of endless tracks.

### SUMMARY OF THE INVENTION

In accordance with the present invention, a novel polymeric endless track is provided which is generally adapted to be mounted on track laying vehicles having drive systems adapted therefor.

Generally speaking, the track comprises a track body defining an inner wheel engaging surface, generally adapted to cooperate with the sprocket wheel, the idler and the road wheels, if any, of the drive system of the vehicle, and an outer ground engaging surface generally adapted to provide traction to the vehicle.

Depending on the type of vehicle and on the type of drive system, the inner surface may be provided with one or more rows of longitudinally aligned and integrally moulded drive lugs adapted to cooperate with the sprocket wheel of the vehicle. Optionally, the inner surface may be provided with one or more rows of longitudinally aligned and integrally moulded guide lugs adapted to guide the track and to prevent detracking thereof. Alternatively, the drive system of the vehicle may cooperate with longitudinally aligned holes provided in the track body. Understandably, combination of drive lugs and holes are within the scope of the invention.

In order to provide traction to the vehicle, a plurality of ground engaging traction lugs are also generally provided on the outer ground engaging surface of the track. Generally, due to the fact that the traction lugs are more rigid and less flexible than the body of the track, the traction lugs are preferably disposed on traction lug areas separated by flexible lug-less hinge areas. Still, the present invention is not so limited.

Advantageously, the skilled addressee will note that some or all of the traction lugs may laterally extend over substantially the full width of the track. In that case, due to their generally laterally extending configuration, these thermoplastic traction lugs can advantageously act as, and effectively replace, the laterally extending core bars usually embedded in prior art elastomeric track. In other words, the thermoplastic traction lugs can provide the lateral structural support previously provided by the laterally extending core bars.

In accordance with an important aspect of the present invention, the track body is preferably made of flexible and resilient thermoplastic materials such as, but not limited to, ultra high molecular weight (hereinafter “UHMW”) polyethylene. Understandably, other thermoplastic materials could also be used. The following non exhaustive list gives a broad range of possible thermoplastic materials: polyethylene, polypropylene, polytetrafluoroethylene, thermoplastic fluoropolymers (e.g. polyperfluoroalkoxyethylene), thermoplastic copolymers (e.g. polyethylene and polypropylene), methylpentene, polyamide (e.g. grades 6, 612, 11) and polyurethane.

In any case, it is preferable that the thermoplastic used in the manufacture of the tracks, listed or not hereinabove, has a molecular weight above 20000 Daltons, preferably above 1000000 Daltons and most preferably above 2000000 Daltons. Also, thermoplastic should have an elasticity modulus generally between 0.2 GPa and 1.2 GPa, and an elastic resistance limit generally between 12 MPa and 24 MPa. Generally, the degree of crystallinity of the thermoplastic material should be above 50% though other values are possible depending on the type of thermoplastic material.

The skilled addressee will note that combinations of thermoplastic materials are also possible. Still, it is generally left to the designer to select an adequate combination that will provide desired characteristics.

Since the track body is likely to be subjected to severe longitudinal strains, the track body is preferably reinforced with reinforcing elements. Accordingly, the track may comprise integrally moulded longitudinally extending cables and/or reinforcing fabrics (e.g. Kevlar™ or Nylon™ fabrics, stitched fabrics, stratified fabrics) and/or continuous or discontinuous fibers (e.g. thermoplastic fibers, natural fibers, glass fibers, carbon fibers, etc.). Other reinforcing elements are also possible.

Since the friction coefficient between certain thermoplastic materials and certain hard surfaces such as ice may be low, the traction lugs formed on the outer surface of the track may advantageously be covered with elastomeric material such as rubber in order to provide enhanced traction between the track and the ground. Understandably, the shape of the thermoplastic traction lugs could be generic whereby the actual shape of the traction lugs would be determined by the shape of the elastomeric material added thereon.

Mechanical traction enhancing elements such as studs may also be mounted to the traction lugs. Also, inserts of elastomeric material such as rubber may be added to the track, and more particularly to the traction lugs thereof, in order to enhance its traction. The present invention is not so limited.

Also, due to the wear to which the track body may be subjected, the inner surface thereof can further be provided with thermoplastic wear pads and/or additional layers of elastomeric materials, such as rubber layers, and/or reinforcing elements.

Still, both the outer surface and the inner surface of the track can be provided with additional layers of elastomeric materials and/or reinforcing elements.

Though generally described as a continuous endless loop, the track of the present invention can also be made from a plurality of flexible segments connected end-to-end via appropriate connectors.

Finally, it is to be understood that, notwithstanding the previous description, with the necessary adaptations, the track of the present invention could be used on other types of vehicles and/or could be embodied into tracks adapted to be mounted over the tires of tire-equipped vehicles. Understandably, the present invention must not be construed as being limited to tracks for use on vehicles equipped with sprocket wheels or other similar drive systems.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a perspective view of a segment of an embodiment of the endless track of the present invention.

FIG. 2 is a top view of the track shown in FIG. 1.

FIG. 3 is a side view of the track shown in FIG. 1.

FIG. 4 is a longitudinal view of the in FIG. 1.

FIG. 5 is a fractional side view of a first variant of the track of FIG. 1.

FIG. 6 is a fractional side view of a second variant of the track of FIG. 1.

FIG. 7 is a fractional side view of a third variant of the track of FIG. 1.

FIG. 8 is a perspective view of a segment of an embodiment of the endless track of the present invention which includes wear pads.

FIG. 9 is a top view of the track shown in FIG. 8.

FIG. 10 is a side view of the track shown in FIG. 8.

FIG. 11 is a longitudinal view of the in FIG. 8.

FIG. 12 is a fragmentary perspective view of the body of the track of FIG. 1.

### DETAILED DESCRIPTION OF THE PREFERRED EMBODIMENT

A novel polymeric endless track will be described hereinafter. Although the invention is described in terms of specific illustrative embodiments, it is to be understood that the embodiments described herein are by way of example only and that the scope of the invention is not intended to be limited thereby.

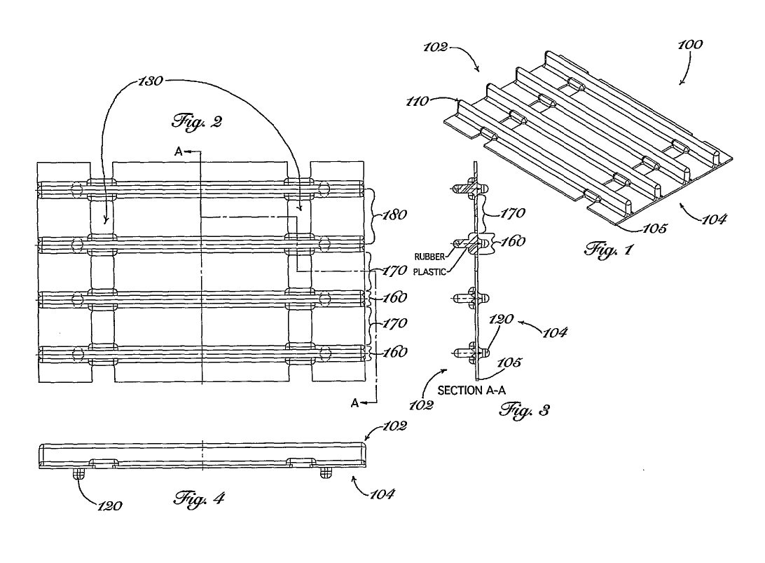

Referring first to FIGS. 1 to 4, a preferred embodiment of the track 100 of the present invention is shown. Though only a portion is shown in FIGS. 1 to 4, the track 100 of the present invention is generally provided as a single continuous belt or as a segmented assembly comprising multiple track segments mounted end-to-end via appropriate connectors. Segmented tracks are generally known in the art and will not be described any further. Furthermore, even though the track 100 shown in FIGS. 1 to 4 is generally configured to be used with snowmobiles and other similar vehicles, the skilled addressee will understand that, with the necessary adaptations, the track 100 could be used with other types of vehicles. Consequently, the invention about to be described below must not be construed as limited to snowmobile tracks.

The track 100 generally comprises a main track body 105 which defines an outer ground engaging surface 102, generally adapted to provide traction, and an inner wheel engaging surface 104, generally adapted to cooperate with the sprocket wheel, idler wheel and road wheels, if any, of the drive system (not shown) of the vehicle (not shown).

In accordance with in important aspect of the present invention, the track 100 is essentially made of flexible and resilient thermoplastic material such as, but not limited to, UHMW polyethylene.

Alternatively, the track 100 could also be manufactured from the following thermoplastic materials: polyethylene, polypropylene, polytetrafluoroethylene, thermoplastic fluoropolymers (e.g. polyperfluoroalkoxyethylene), thermoplastic copolymers (e.g. polyethylene and polypropylene), methylpentene, polyamide (e.g. grades 6, 612, 11) and polyurethane. Combinations of two or more thermoplastic materials are also possible.

In any case, it is preferable that thermoplastic used in the manufacture of the tracks, listed or not hereinabove, has a molecular weight above 20000 Daltons, preferably above 1000000 Daltons and most preferably above 2000000 Daltons. Additionally, it is preferably that the thermoplastic has an elasticity modulus generally between 0.2 GPa and 1.2 GPa, and an elastic resistance limit generally between 12 MPa and 24 MPa. Generally, the degree of crystallinity of the thermoplastic material should be above 50% though other values are possible depending on the type of thermoplastic material.

Though it is understood that certain thermoplastic materials may not have adequate physical and mechanical properties to serve as the base material of an endless track, it is to be understood that the skilled addressee will be able to determine which thermoplastic materials are flexible enough and resilient enough to be appropriate as such base material. The present invention is therefore generally not limited to any particular thermoplastic materials.

Provided on the outer surface of the track and preferably integrally moulded thereto are laterally extending traction lugs 110. Since the traction lugs 110 tend to be more rigid than the body 105 of the track 100, the traction lugs 110 are preferably disposed on lug areas 160 separated by flexible lug-less hinge areas 170. Even though each lug area 160 is shown supporting a single the traction lug 110 extending over the full width of the track 100, each lug area 160 could also be provided with several laterally space apart smaller traction lugs 110. The present invention is not so limited.

In any case, it is preferable to have at least some of the traction lugs 110 to extend over the full width of the track 100 is order to provide lateral rigidity to the body 105 of the track 100. These laterally extending traction lugs 110 can act as, and effectively replace, the core bars previously embedded into tracks.

In order to provide an effective track 100, the thickness of the body 105 of the track 100 along the hinge areas 170 must allow the track 100 to bend around the sprocket and/or idler wheels of the vehicle without breaking.

In the case of a standard snowmobile track, wherein the elastic modulus of the thermoplastic (e.g. UHMW polyethylene) is between 0.6 and 0.8, the thickness of the track 100 along the hinge areas 170 should preferably be between 0.254 cm (0.100 inch) and 0.508 cm (0.200 inch) and most preferably around 0.3556 cm (0.140 inch).

Also, since thermoplastics are generally less flexible than elastomeric material such as rubber, the ratio between the thickness of the track 100 along the hinge areas 170 and the radius of the wheels (i.e. sprocket wheel and idler wheel) around which the track 100 travels should have an upper limit of 0.06. In the case of UHMW polyethylene, the preferred value should be around 0.035.

It has also been found advantageous to have a maximum ratio of 0.45 between the length of the traction lug areas 160 and the pitch 180 of the track 100. Preferably, but not exclusively, in the case of UHMW polyethylene, the ratio should be below 0.15.

Understandably, the above-mentioned parameters and ratios will vary depending on the exact physical and mechanical properties of the thermoplastic and on the type of vehicle onto which the track is installed. Hence, different types of vehicles may require different types of tracks having different parameters and ratios.

The inner surface 104 of the body 105 of the track 100 is generally provided with guide lugs 120. The guide lugs 120 are generally adapted to cooperate with the drive and/or suspension systems of the vehicle, in this case, a snowmobile (not shown). As for the traction lugs 110, the guide lugs 120 are preferably integrally moulded with the body 105 of the track 100. Also, as best shown in FIG. 3, the guide lugs 120 are generally longitudinally aligned with the traction lugs 110 on the lug areas 160.

As best shown in FIGS. 1 and 2, the body 105 of the track 100 is provided with two rows of longitudinally aligned holes 130 which may or may not receive therethrough the sprocket teeth of the sprocket wheel. The holes 130 are generally provided in the hinge areas 170 of the track 100. Understandably, given the fact that the present invention is not limited to snowmobile tracks, different drive systems provided on different types of vehicles may require different track configurations. Therefore, tracks 100 made according to the present invention may or may not be provided without holes 130. Furthermore, tracks 100 made according to the present invention may or may not be provided without drive lugs (not shown) adapted to mesh with the sprocket wheel of the drive system. The present invention is not so limited.

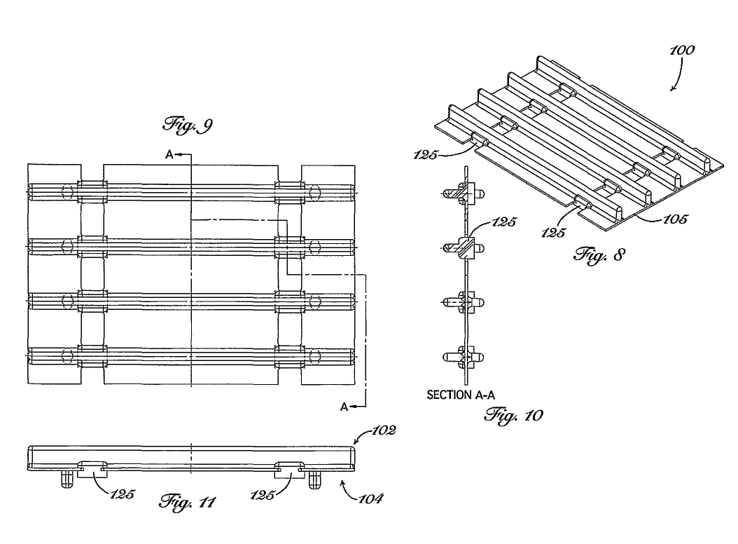

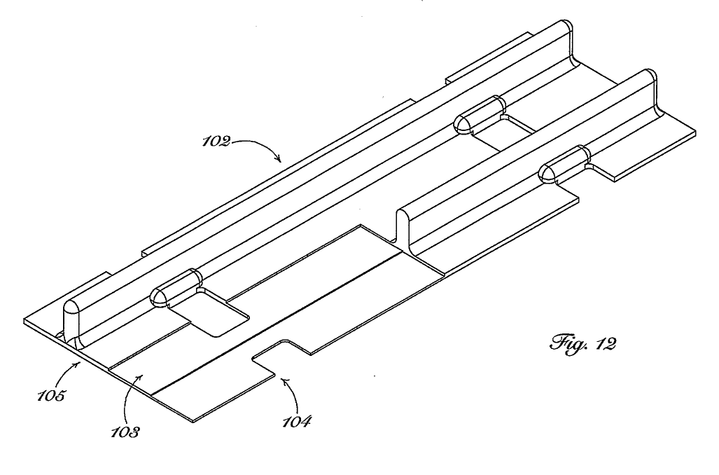

Advantageously, the inner surface 104 of the track 100 may be provided with thermoplastic wear pads 125 (see FIGS. 8 to 11) preferably integrally moulded to the track 100. In the case of snowmobile track, these wear pads 125 could replace metallic clips previously mounted to the track 100. In order to provide an adequate longevity, the wear pads 125 should have a thickness of at least 0.381 cm (0.150 inch) and preferably a thickness between 0.762 cm (0.300 inch) and 1.27 cm (0.500 inch).

Since the wear pads 125 tend to rigidify the track 100 around the transition between the hinge areas 160 and the lug areas 170, it is preferable to provide the track 100 with the holes 130 on each side of the pads 125 even though these holes 130 are not engaged by the sprocket wheel of the vehicle. By providing holes 130, there are no transition between the hinge areas 160 and the lug areas 170 near the wear pads 125 whereby the wear pads 125 do not rigidify the track 100.

Even though certain thermoplastic materials are strong enough to support the longitudinal strains to which they will be subjected during use, it is generally preferable to provide the body 105 of the track 100 with reinforcing fabrics and/or other similar reinforcing elements 103. As shown in FIG. 12, these reinforcing elements 103 are generally integrally moulded into the body 105 of the track during fabrication thereof.

In order to provide a solid mechanical link between the thermoplastic material of the body 105 and the reinforcing fabrics, it is preferable to use open reinforcing fabrics since the openings therein allow the thermoplastic to flow therethrough during the manufacturing process of the of track 100. It is also preferable to keep the reinforcing elements (e.g. fabrics) substantially centered during the manufacturing process of the of track 100 in order to prevent the creation of weak zones in the track 100.

Understandably, though not shown, the track 100 could also be reinforced with longitudinally extending cords or cables, continuous or discontinuous fibers (e.g. e.g. thermoplastic fibers, natural fibers, glass fibers, carbon fibers, etc.).

Still, since some reinforcing elements may not directly adhere to certain thermoplastics (e.g. UHMW polyethylene), it is possible to use rubber as a bonding agent since rubber is one of the limited number of materials which easily adhere to thermoplastic materials and more particularly, to UHMW polyethylene.

Though the track 100 of the present invention may be used in its bare form, embodiments including additional layers of material are possible and, in certain circumstances, preferable.

Now referring to FIG. 5, a first variant of the track 100 is disclosed. In this variant, the traction lugs 110 of the track 100 are covered with one or more layers 150 of elastomeric materials (e.g. rubber) and/or reinforcing materials (e.g. reinforcing fabrics). Preferably, the layers 150 are of elastomeric materials in order to increase the traction of the track 100 on hard surfaces such as ice. Also, the layer or layers 150 are generally thermally and/or chemically bonded to the thermoplastic traction lugs 110 and moulded to a desired shape during the manufacturing process of the track 100.

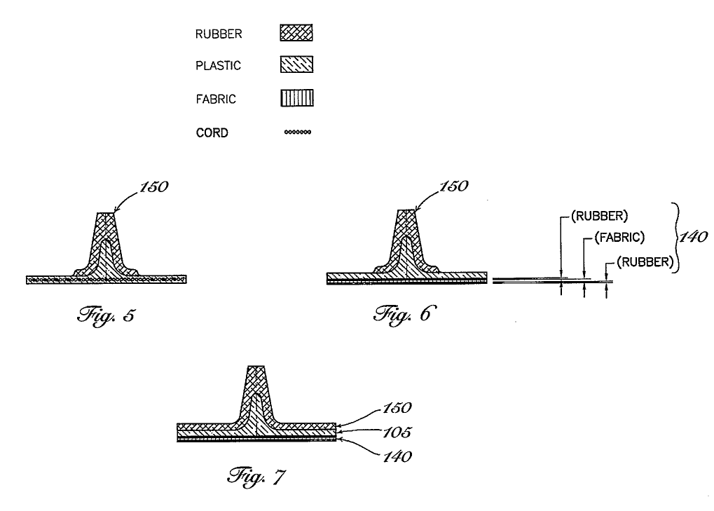

FIG. 6 shows another variant of the track 100 of the present invention in which, in addition of the layer or layers 150 disposed on the traction lugs 110, the inner surface 104 has been provided with additional layers 140 of elastomeric materials and/or reinforcing elements. In the exemplary variant of FIG. 6, the inner surface 104 of the track 100 has been provided with three additional layers, layers 141 and 143 elastomeric materials (e.g. rubber) and layer 142, disposed between layers 106 and 108, of reinforcing materials (e.g. reinforcing fabrics). Understandably, more or less additional layers could be provided, the invention is not so limited. In any case, the additional layers 140 should generally be thermally and/or chemically bonded to the inner surface 104 of the track 100 during manufacturing process thereof.

FIG. 7 shows still another variant of the track 100 of the present invention. The track 100 of FIG. 7 comprises, as the track 100 of FIG. 6, one or more additional layers 140 on the inner surface thereof. However, whereas in FIG. 6, only the traction lugs 110 were covered with one or more layers 150, in the track of FIG. 7, the whole outer surface 102 is provided with additional layer or layers 150. Thus, in the track of FIG. 7, both the traction lug areas 160 and the lug-less hinge areas 170 separating consecutive lug areas 160 are covered with the additional layer or layers 150. Thus, in the embodiment of FIG. 7, the thermoplastic body 105 of the track 100 is effectively disposed intermediate between one or more outer layers 150 and one or more inner layers 140. Understandably, both the outer layer(s) 150 and the inner layer(s) 140 are preferably thermally and/or chemically bonded to their respective outer and inner surfaces.

The skilled addressee will note that thermoplastic material and elastomeric material cannot be formed or pressed in exactly the same manner. Also, since, as raw material, thermoplastic materials can come in a plurality of forms, the track 100 of the present invention can be manufactured according to different processes.

One of the preferred processes includes the steps of:

a) providing a mould adapted to mould at least a portion of the track;

b) optionally, partially filling the traction lugs portions of the mould with elastomeric and/or thermosetting materials;

c) filling the traction lugs portions of the mould with thermoplastic powder or pellets;

d) forming the traction lugs by pressing, and optionally heating, the mould;

e) adding reinforcing elements (e.g. cords, cables, fabrics, fibers) in the mould;

f) optionally, adding elastomeric material in the mould;

g) covering the reinforcing elements, and the elastomeric material if any, with thermoplastic powder or pellets;

h) optionally, partially filling the drive lugs portions of the mould with elastomeric and/or thermosetting materials;

i) while preferably mechanically maintaining the position of the reinforcing elements, if any, pressing, and optionally heating, the mould to form the body of the track;

j) extracting the track segment from the mould.

In the previous process, the sub-step of mechanically maintaining the position of the reinforcing elements may be omitted if the reinforcing elements, such as stratified reinforcing fabrics, are rigid enough to maintain their position during the process. The invention is therefore not so limited.

Understandably, the previous method can be greatly simplified if there are no addition of elastomeric and/or thermosetting materials and no addition of reinforcing elements. In that case, the track could generally be formed following the steps of:

a) providing a mould adapted to mould at least a portion of the track;

b) filling the mould with thermoplastic powder or pellets;

c) pressing, and optionally heating, the mould to form the track;

d) extracting the track from the mould.

Since some tracks may be manufactured by repeating the steps of one of the two previous processes for each longitudinal portions or segments thereof, it is preferable to use temperature transition zones at the extremities of the formed portions or segments of the track in order to prevent the deformation thereof. The use of removable stoppers at each extremities of the track during the manufacturing process may also be required in order to prevent discontinuity in the compressing.

Though the track of the present invention can be continuous or segmented, in the case of continuous tracks, it is generally necessary to connect both extremities thereof in order to obtain a continuous loop. To do so, the following steps can be effected:

a) placing both extremities of the track next to each other to define a joint area;

b) adding thermoplastic powder or pellets on the joint area;

c) heating and pressing the joint area.

Alternatively, in the previous process, step b) could be replaced by:

b) adding thermosetting plastic material on the joint area;

wherein the thermosetting material is preferably an elastomeric material such as rubber.

However, depending on the type of presses used to form the track, it could be possible to form a continuous track in a single pressing step. Still, the use of circular presses is generally required.

Understandably, the track of the present invention could be manufactured with thermoplastic provided in other forms such as sheets, rolls and/or compressed preformed elements. Accordingly, the previous processes could be adapted to take into account the form in which the thermoplastic material is provided. Additionally, the track may be formed by direct injection of molten thermoplastic, and optionally elastomeric material, into the mould or by injection and compression of molten thermoplastic, and optionally elastomeric material, into the mould. The present invention is therefore not so limited.

Notwithstanding the processes, it remains generally preferable to maintain the position of the reinforcing elements during the moulding process and to provide enough compression in the hinge areas of the track in order to obtain a solid track.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A method to manufacture a polymeric track for use on a vehicle, said track being made from flexible and resilient thermoplastic material and defining an inner wheel engaging surface and an outer ground engaging surface comprising, said method comprising the steps of:
providing a mould adapted to mould said track;
placing a first layer of said thermoplastic material into said mould;
placing reinforcing elements into said mould;
placing a second layer of said thermoplastic material into said mould;
pressing and heating said mould to melt said thermoplastic material and to form said track.

2. A method as claimed in claim 1, wherein said first layer of said thermoplastic is provided in powder or pellets or sheets.

3. A method as claimed in claim 1, wherein said second layer of said thermoplastic is provided in powder or pellets or sheets.

4. A method as claimed in claim 1, wherein said reinforcing elements are reinforcing fabrics.

5. A method as claimed in claim 1, wherein said reinforcing elements are fibers.

6. A track as obtained from the method of claim 1.
